(19) United States
(12) Patent Application Publication
(10) Pub. No.: US 2025/0376043 A1
(43) Pub. Date: Dec. 11, 2025

(54) Method for Operating a Drive Assembly of an Electric Bicycle

(71) Applicant: Robert Bosch GmbH, Stuttgart (DE)

(72) Inventor: Joseph Reck, Weil Im Schoenbuch (DE)

(21) Appl. No.: 19/229,916

(22) Filed: Jun. 5, 2025

(30) Foreign Application Priority Data
Jun. 7, 2024 (DE) 10 2024 205 291.4

(51) Int. Cl. B60L 15/20; B60L 50/20

(52) U.S. Cl. CPC B60L 15/20; B60L 50/20; B60L 2200/12; B60L 2240/421; B60L 2240/423; B60L 2250/26

(57) ABSTRACT

A method for operating a drive assembly of an electric bicycle includes (i) actuating, in a controlled manner, a motor of the drive assembly to generate a predetermined test torque, (ii) determining an engagement state of a drive train of the electric bicycle, (iii) detecting a rotary movement of the motor, and (iv) recognizing a start-up operation in response to the detection of the engagement state and when the detected rotary movement is at least equal to a predetermined start-up rotary movement.

This application claims priority under 35 U.S.C. § 119 to application no. DE 10 2024 205 291.4, filed on Jun. 7, 2024 in Germany, the disclosure of which is incorporated herein by reference in its entirety.

### BACKGROUND

The present disclosure relates to a method for operating a drive assembly of an electric bicycle, a drive assembly of an electric bicycle, as well as to an electric bicycle.

Electric bicycles are known with drive assemblies which have a motor for generating motor torque to provide motor assistance to the manual pedaling force of a rider. In many cases, the generation of the motor torque depends on various conditions. Due to the plurality of components in such drive assemblies, reliable detection of all fulfilled requirements is often complex and can be prone to errors.

### SUMMARY

The method according to the disclosure with the features set forth below is characterized in that a start-up operation of an electric bicycle can be detected in a particularly simple and reliable manner, based on which the motor torque can preferably be provided reliably and in a targeted manner. This is achieved according to the disclosure by a method for operating a drive assembly of an electric bicycle, comprising the steps of:
actuating, in a controlled manner, a motor of the drive assembly to generate a predetermined test torque,
determining an engagement state of a drive train of the electric bicycle,
detecting a rotary movement of the motor, and
recognizing a start-up operation in response to the detection of the engagement state and when the detected rotary movement is at least equal to a predetermined start-up rotary movement.

A fully tensioned state of the drive train is considered to be an engagement state. In particular, an engagement state is considered to be a state in which torque is transmitted in relation to a forward direction of travel. This means that in the engagement state, the drive train is tensioned in such a way that, in particular, play and/or free travel and/or elasticity of parts of the drive train, such as a bicycle chain, and mechanical engagement between the bicycle chain and sprockets are essentially completely eliminated.

For example, the engagement state can be determined using sensors, in particular one or more torque and/or speed sensors.

Rotary movement is understood in particular to mean the rotation of a rotor of the motor.

Start-up operation is understood in particular to mean that the electric bicycle, preferably at a standstill, has a tensioned drive train and that immediate start-up is possible by applying motor torque and/or pedaling torque.

In other words, the method involves specifically actuating the motor of the drive assembly with the test torque in order to achieve a certain rotation of the motor. In addition, the engagement state of the drive train is specifically detected, i.e., it is determined whether torque transmission via the drive train is currently possible without first overcoming play, idle travel, or elasticity. If, in particular after the engagement state has been detected, a rotary movement of the motor is detected, the start-up operation is detected if the detected rotary movement is at least equal to a predetermined start-up rotary movement.

The method therefore offers the advantage that it is possible to determine in a particularly simple and reliable way whether the current state of the motor and the drive train of the electric bicycle allows torque to be generated for propulsion. In particular, it can be determined whether the motor and/or the drive process is blocked. The method can preferably be carried out essentially in a purely software-based manner. The method thus enables particularly reliable operation of the electric bicycle with a high level of user comfort for the rider

Preferred further modifications of the disclosure are set forth below.

Preferably, the method further comprises the following step: releasing a full motor torque generation of the motor in response to detecting the start-up operation. This means that when the start-up operation is detected positively, the full motor torque is released in a controlled manner. Recognizing the start-up operation using this method therefore provides a particularly reliable and simple criterion for releasing the motor torque.

Preferably, the method prevents the motor from generating torque in response to a failed detection of the start-up operation. This means that if, during the execution of the method, the start-up operation fails to be detected, for example because the engagement state is not determined and/or because the rotary movement of the motor is not detected, the motor torque generation of the motor can be prevented in a targeted manner.

In particular, the detection of the rotary movement of the motor comprises detecting a motor speed. The start-up operation is then detected when, during the determined engagement state, the motor speed is at least equal to a predetermined start-up speed for at least a predetermined period of time. In particular, the predetermined start-up speed is at least three revolutions per minute, preferably at least five revolutions per minute. This means that the start-up operation can be detected when the motor can rotate at least at the predetermined start-up speed with the drive train under load. This allows detection to be implemented in a particularly simple and cost-effective manner.

Furthermore, the detection of the rotary movement of the motor preferably comprises a detection of a motor angle. The start-up operation is then detected when the detected motor angle is at least equal to a predetermined start-up motor angle. The motor angle is in particular regarded as a predetermined rotation of the motor by a certain angle. The start-up motor angle can, for example, correspond to an angle traveled of at least 10 degrees, preferably at least 20 degrees. It is particularly preferred that the start-up operation is detected based on the motor angle when the motor angle is detected during the determined engagement state. Alternatively, the start-up operation can also be detected based on the motor angle without detecting an engagement state. In this case, a larger predetermined start-up angle is preferably used, upon reaching which it is assumed that the start-up operation is taking place. This means that the start-up operation of the electric bicycle can be determined in a further particularly simple and reliable manner by way of the method.

It is particularly preferred to determine the engagement state based on determining a motor torque of the motor and determining a drive torque in the drive train. Preferably, the drive torque is determined at a chainring and/or at a rear wheel. For example, the motor torque and/or the drive torque can be detected directly, in particular by way of a torque sensor. Alternatively or additionally, the motor torque and/or the drive torque can be calculated, for example based on other operating variables and known mechanical relationships. For example, the motor torque can be calculated based on an operating current of the motor. The drive torque can preferably be determined based on a known transmission ratio and the mechanical properties of the drive train. By determining the torques, the engagement state can be determined particularly reliably and precisely.

The engagement state is preferably detected when the determined drive torque is greater than or equal to the determined motor torque. In this case, it can be assumed that any play and/or elasticity in all components of the motor and drive train has been essentially completely eliminated. This means that, based on the detection that the drive torque is greater than or equal to the determined motor torque, it can be detected that the motor can directly and immediately exert a torque via the drive train to propel the electric bicycle.

Preferably, the drive torque in the drive train is determined by way of a sensor, in particular a torque sensor. For example, the sensor can detect the drive torque on a chainring or on a cassette on a rear wheel of the electric bicycle. This allows the drive torque to be determined particularly precisely in a simple manner.

Preferably, the drive torque in the drive train is determined by calculation based on a determined motor torque of the motor and a mathematical model of the drive train. The motor torque can preferably be detected by way of a torque sensor and/or determined based on an electrical actuating current and the known characteristics of the motor. This means that the drive torque can be calculated based on the mechanical and geometric relationship of the torque transmission path from the motor via the drive train. This eliminates the need for additional sensors in the drive train. Thus, the drive torque can be calculated purely on a software basis, for example. This enables the method to be implemented in a particularly simple and cost-effective manner.

Preferably, the method further comprises the following step: detecting a blocked state of the drive train when, in response to the detected engagement state, the predetermined start-up rotary movement remains undetected within a predetermined period of time. Alternatively or additionally preferably, the motor can be recognized as blocked if the predetermined start-up rotary movement remains undetected. This means that if, in response to the detected engagement state of the drivetrain, it is recognized that no rotary movement of the motor is possible, the blocked state is assumed.

Preferably, the method further comprises the following step: Preventing full motor torque generation in response to detection of a blocked condition of the drive train, in particular and/or of the motor. This means that motor assistance by way of torque generation is specifically prevented when the blocked condition of the drive train is detected. This can, for example, prevent unwanted operation of the motor in the event of defects or similar.

Preferably, the test torque is a maximum of 10 percent of a predetermined maximum torque of the motor. Alternatively or additionally, the test torque is a maximum of 5 Nm. The maximum torque is defined in particular as the maximum torque that can be provided by the motor under full load. This ensures that the test torque does not cause any significant propulsion of the electric bicycle. The procedure can therefore be carried out essentially unnoticed by the rider of the electric bicycle. This provides a particularly high level of user comfort for the rider.

Preferably, the method is carried out exclusively during a standstill of the electric bicycle. For example, the standstill can be detected using sensors. This means that the method can be used during standstill, in particular before the electric bicycle starts moving, to check whether torque can be provided by the motor and released.

Furthermore, the disclosure leads to a drive assembly for an electric bicycle. The drive assembly comprises a motor, a drive train, and a control unit which is configured to control the motor. The control unit is also configured to carry out the described method.

Further, the disclosure relates to an electric bicycle comprising the described drive assembly.

### BRIEF DESCRIPTION OF THE DRAWINGS

An exemplary embodiment of the disclosure is explained in detail below with reference to the accompanying drawings.

FIG. 1 is a simplified schematic view of an electric bicycle in which a method to operate a drive assembly of an electric bicycle according to a preferred exemplary embodiment example of the disclosure is carried out, and

FIG. 2 is a highly simplified schematic view of the method according to the disclosure.

### DETAILED DESCRIPTION

Preferably, all identical components, elements, and/or units are provided with the same reference symbols in all figures.

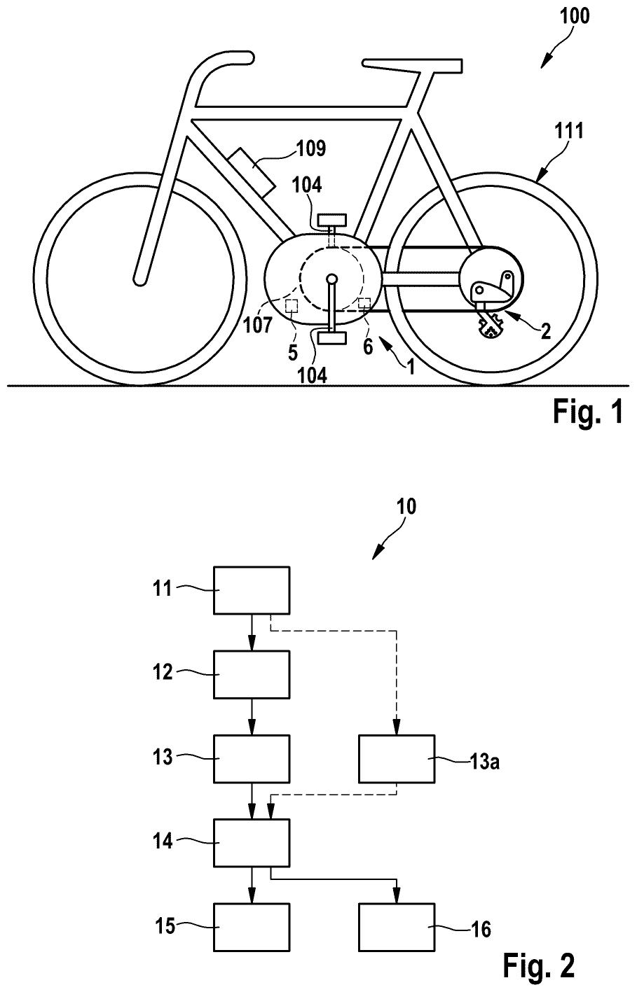

FIG. 1 shows a simplified schematic view of an electric bicycle 100 in which a method to operate a drive assembly 1 of an electric bicycle 100 according to a preferred exemplary embodiment of the disclosure is carried out.

The drive assembly 1 comprises a motor 2, which is in particular an electric motor. The motor 2 can be supplied with electrical energy by way of an electrical energy storage unit 109 of the electric bicycle 100.

The drive assembly 1 is disposed in the region of a pedal bracket of the electric bicycle 100. A motor torque generated by the motor 2 can be used to provide motorized support for the pedal force generated by the muscle power of a rider of the electric bicycle 100. The muscle power of the rider can be applied via a crank mechanism with crank levers 104.

The drive assembly 1 further comprises a control unit 5, which is configured so as to actuate the motor 2 in a controlled manner. For example, the control unit 5 can control an electrical actuation current for actuating the motor 2.

The control unit 5 is configured to carry out the method 10 according to the disclosure for operating the drive assembly 1. The method 10 is used to test whether the motor 2 and/or the drive train 3 of the electric bicycle 100 is blocked. Based on this, the motor torque generation of the motor 2 can be prevented or released. The method 10 is described below with reference to FIG. 2.

The method 10 is carried out exclusively when the electric bicycle 100 is at a standstill. In particular, the standstill can be detected by way of sensors.

Preferably, the method 10 can also be carried out in response to an estimated imminent start-up operation. For example, the imminent start-up operation can be detected in response to a detected actuation by the rider of the electric bicycle 100.

The method 10 can be carried out with particular preference in response to activation of the entire system and/or the electrical energy storage unit 109 of the electric bicycle 100.

In method 10, the motor 2 is first actuated, in a controlled manner, 11 in order to generate a predetermined test torque. The actuation 11 is performed by the control unit 5, in particular by supplying a corresponding actuating current.

The test torque is preferably a maximum of 5 Nm, i.e., a small torque is generated which is preferably not sufficient to propel the electric bicycle 100.

Preferably, the controlled actuation 10 takes place for a predetermined period of time, for example at least 1 second, preferably a maximum of 3 seconds.

This is followed, in particular during controlled actuation 11, by determination 12 of an engagement state of the drive train 3 of the electric bicycle 100.

The determination 12 of the engagement state is based on a motor torque of the motor 2 and a drive torque in the drive train 3.

The motor torque can be determined by way of a sensor 6. The sensor 6 can, for example, be a torque sensor which directly detects the instantaneous motor torque. Alternatively, the sensor 6 can be configured to detect the operating current of the motor 2, wherein the motor torque is calculated based on the operating current.

The drive torque in drive train 3 is preferably also determined by way of sensor 6. In this case, the drive torque can preferably be detected directly by way of sensor 6 by detecting a torque on a chainring 107.

Alternatively, the drive torque can preferably be calculated based on the motor torque determined as described above. In addition, a mechanical transmission path of the drive assembly 1 and a current transmission ratio can be used.

The current transmission ratio can be known in advance, for example based on a controllably actuated gear shift, and/or determined using sensors, for example using speed sensors.

The engagement state 12 of the drive train 3 is determined such that the engagement state is detected when the determined drive torque is greater than or equal to the determined motor torque. Preferably, a certain tolerance factor can also be taken into account so that, for example, the engagement state is detected when the drive torque is more than 80 percent of the determined motor torque.

If the engagement state has been determined in this way, it can be assumed that drive train 3 is fully tensioned. This means that any play, dead travel, and elasticity of the drive train components have been essentially completely overcome. Such free travel, elasticity, and play can occur, for example, due to the bicycle chain, freewheels, mechanical interactions between the bicycle chain and the sprocket, and the like.

Furthermore, in method 10, while the determined engagement state is present, a rotary movement of the motor 2 is detected 13. In particular, the rotary movement is detected by way of the sensor 6.

Then, in method 10, a start-up operation is detected 14 if, during the determined engagement state, the detected rotary movement is at least equal to a predetermined start-up rotary movement.

In detail, the detection 13 of the rotary movement of the motor 2 comprises a detection of a motor angle and/or a motor torque. A predetermined start-up rotary movement is regarded as a predetermined start-up speed or a predetermined start-up motor angle. This means that if the motor speed detected in step 13 exceeds the predetermined start-up speed, the start-up operation is detected in step 14. Alternatively or additionally, the start-up operation is preferably detected if the detected motor angle is greater than or equal to the predetermined start-up motor angle.

Alternatively, as characterized by step 13a in FIG. 2, the start-up operation can also be recognized 14 without explicitly determining 12 the engagement state of the drive train 3. In this case, the start-up operation can also be detected if a predetermined target start-up motor angle is detected 13a, which is preferably significantly greater than the predetermined start-up motor angle of step 13 and which is, in particular, at least 3 degrees.

In step 14, it can thus be detected that motor 2 and drive train 3 of electric bicycle 100 are in an unblocked state.

Based on this, full motor torque generation of motor 2 can then be enabled 15 in response to the detection 14 of the start-up operation. This means that, upon enabling 15, the drive assembly 1 is placed in an operational state, in particular by way of the control device 5, in which, preferably depending on a pedaling torque generated by the driver, assistance can be provided by way of the motor torque generated by the motor 2, wherein the motor torque can be provided in full.

If the start-up operation is not detected 14 and if, in response to the detected engagement state within a predetermined period of time during the actuation of motor 2, the predetermined start-up rotary movement remains undetected, a blocked state of drive train 3 is detected 16. This means that in this case, it can be detected in step 16 that motor 2 and/or drive train 3 are blocked.

In response to the detection 16 of the blocked state of the drive train 3, full motor torque generation by motor 2 is then prevented. For example, motor torque generation by motor 2 can be completely deactivated so that no motor torque can be generated.

The method 10 thus allows, in a particularly simple and cost-effective manner, reliable detection of whether a start-up operation and thus a possibility of torque generation by the motor 2 can be enabled. In particular, blocked and unblocked states of the drive train 3 can be reliably determined. Based on this, the motor torque can be provided with particular precision and reliability. This is made possible by the special determination of the engagement state, wherein it is ensured that dead travel, elasticities, and play in the drive train 3 are essentially completely eliminated. This allows the test of the rotary movement of the motor 2 to be carried out particularly reliably and precisely.

What is claimed is:

1. A method for operating a drive assembly of an electric bicycle, comprising:
actuating, in a controlled manner, a motor of the drive assembly to generate a predetermined test torque;
determining an engagement state of a drive train of the electric bicycle;
detecting a rotary movement of the motor; and
recognizing a start-up operation in response to the detection of the engagement state and when the detected rotary movement is at least equal to a predetermined start-up rotary movement.

2. The method according to claim 1, further comprising enabling full motor torque generation of the motor in response to detecting the start-up operation.

3. The method according to claim 1, wherein the detecting of the rotary movement of the motor comprises detecting a motor speed, and wherein the recognizing of a start-up operation takes place if, during the determined engagement state, the motor speed is at least equal to a predetermined start-up speed for at least a predetermined period of time.

4. The method according to claim 1, wherein detecting the rotary movement of the motor comprises detecting a motor angle, and wherein start-up operation is recognized when the detected motor angle is at least equal to a predetermined start-up motor angle.

5. The method according to claim 1, wherein the determination of the engagement state is based on a determination of a motor torque of the motor and a determination of a drive torque in the drive train at a chainring and/or at a rear wheel.

6. The method according to claim 5, wherein the engagement state is detected when the determined drive torque is greater than or equal to the determined motor torque.

7. The method according to claim 5, wherein the drive torque in the drive train is determined by way of a sensor.

8. The method according to claim 5, wherein the drive torque in the drive train is determined by calculation based on a determined motor torque of the motor and a mathematical model of the drive train.

9. The method according to claim 1, further comprising:
detecting a blocked state of the drive train when, in response to the detected engagement state, the predetermined start-up rotary movement remains undetected within a predetermined period of time.

10. The method according to claim 9, further comprising:
preventing full motor torque generation of the motor in response to the detection of the blocked state of the drive train.

11. The method according to claim 1, wherein the test torque corresponds to a maximum of 10% of a maximum torque of the motor, and/or wherein the test torque is a maximum of 5 Nm.

12. The method according to claim 1, wherein the method is performed exclusively during a standstill of the electric bicycle.

13. A drive assembly of an electric bicycle, comprising:
a motor;
a drive train; and
a control unit which is set up for actuating the motor, wherein the control unit is set up for carrying out the method according to claim 1.

14. An electric bicycle comprising a drive assembly according to claim 13.
